(19) United States
(12) Patent Application Publication
(10) Pub. No.: US 2013/0027254 A1
(43) Pub. Date: Jan. 31, 2013

(54) MULTIBAND SLOT LOOP ANTENNA APPARATUS AND METHODS

(71) Applicants: Heikki Korva, Tupos (FI); Petteri Annamaa, Oulunsalo (FI)

(72) Inventors: Heikki Korva, Tupos (FI); Petteri Annamaa, Oulunsalo (FI)

(21) Appl. No.: 13/190,363

(22) Filed: Jul. 25, 2011

(51) Int. Cl. H01Q 1/24; H01Q 1/00; H01Q 7/00; H01Q 5/00

(52) U.S. Cl. 343/702; 343/700 MS; 343/722; 343/866

(57) ABSTRACT

A multiband slot loop antenna apparatus, and methods of tuning and utilizing the same. In one embodiment, the antenna configuration is used within a handheld mobile device (e.g., cellular telephone or smartphone). The antenna comprises two radiating structures: a ring or loop structure substantially enveloping an outside perimeter of the device enclosure, and a tuning structure disposed inside the enclosure. The ring structure is grounded to the ground plane of the device so as to create a virtual portion and an operating portion. The tuning structure is spaced from the ground plane, and includes a plurality of radiator branches effecting antenna operation in various frequency bands; e.g., at least one lower frequency band and three upper frequency bands. On one implementation, a second lower frequency band radiator is effected using a reactive matched circuit coupled between a device feed and a radiator branch.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to antenna apparatus for use in electronic devices such as wireless or portable radio devices, and more particularly in one exemplary aspect to a multiband slotted loop or ring antenna, and methods of tuning and utilizing the same.

### DESCRIPTION OF RELATED TECHNOLOGY

Internal antennas are an element found in most modern radio devices, such as mobile computers, mobile phones, Blackberry® Blackberry devices, smartphones, personal digital assistants (PDAs), or other personal communication devices (PCDs). Typically, these antennas comprise a planar radiating plane and a ground plane parallel thereto, which are connected to each other by a short-circuit conductor in order to achieve the matching of the antenna. The structure is configured so that it functions as a resonator at the desired operating frequency. It is also a common requirement that the antenna operate in more than one frequency band (such as dual-band, tri-band, or quad-band mobile phones), in which case two or more resonators are used.

Recent advances in the development of affordable and power-efficient display technologies for mobile applications (such as liquid crystal displays (LCD), light-emitting diodes (LED) displays, organic light emitting diodes (OLED), thin film transistors (TFT), etc.) have resulted in a proliferation of mobile devices featuring large displays, with screen sizes of for instance 89-100 mm (3.5-4 in.) in mobile phones, and on the order of 180 mm (7 in.) in some tablet computers. To achieve the best performance, display ground planes (or shields) are commonly used. These larger ground planes are required by modem displays, yet are no longer optimal for wireless antenna operation. Specifically, this lack of optimization stems from the fact that ground plane size plays a significant role in the design of the antenna for the air interface(s) of the device. As a result, antenna bandwidth is reduced due to, at least in part, impedance mismatch between antenna radiator and the large ground plane.

Furthermore, current trends increase demand for thinner mobile communications devices with large displays that are often used for user input (e.g., touch screen). This in turn requires a rigid structure to support the display assembly, particularly during the touch-screen operation, so as to make the interface robust and durable, and mitigate movement or deflection of the display. A metal body or a metal frame is often utilized in order to provide a better support for the display in the mobile device.

The use of metal enclosures/chassis, large ground planes, and the requirement for thinner device enclosure create new challenges for radio frequency (RF) antenna implementations. Typical antenna solutions (such as monopole, PIFA antennas) require ground clearance area and sufficient height from ground plane in order to operate efficiently in multiple frequency bands (a typical requirement of modem portable devices). These antenna solutions are often inadequate for the aforementioned thin devices with metal housings and/or chassis, as the vertical distance required to separate the radiator from the ground plane is no longer available. Additionally, the metal body of the mobile device acts as an RF shield and degrades antenna performance, particularly when the antenna is required to operate in several frequency bands

Various methods are presently employed to attempt to improve antenna operation in thin communication devices that utilize metal housings and/or chassis, such as for example a slot ring antenna described in European Patent Publication number EP1858112B1. This implementation requires fabrication of a slot within the printed wired board (PWB) in proximity to the feed point, as well as along the entire height of the device. For a device having a larger display, a slot location that is required for optimal antenna operation often interferes with device user interface functionality (e.g. buttons, scroll wheel, etc), therefore limiting device layout implementation flexibility.

Additionally, such metal housing must have openings in close proximity to the slot on both sides of the PCB. To prevent generation of radio frequency cavity modes within the device, the openings are typically connected using metal walls. All of these steps increase device complexity and cost, and impede antenna matching to the desired frequency bands of operation.

Another existing implementation employs a multi-resonant coupled feed antenna comprising a metal ring radiating element fitted around perimeter of the radio device. Several slots are fabricated within the radiator (typically on the sides) in order to achieve multiband antenna functionality; this approach unfortunately increases the cost and complexity of the device. Given that device users typically handle communication devices by their sides/edges, such configuration is susceptible to antenna detuning and communication failures due to a short circuit created when a user hand touches the radiator over the slot. Furthermore, wide slots (typically about 3 mm in width) are required to achieve the desired low band (typically 700-960 MHz) operation, and as such may adversely affect device aesthetic appeal.

Accordingly, there is a salient need for a wireless multiband antenna solution for e.g., a portable radio device, with a small form factor and which is suitable for the device perimeter, and that offers a lower cost and complexity, as well as providing for improved control of antenna resonance.

### SUMMARY OF THE INVENTION

The present invention satisfies the foregoing needs by providing, inter alia, a space-efficient multiband antenna apparatus, and methods of tuning and use thereof.

In a first aspect of the invention, a mobile communications device is disclosed. In one embodiment, the device comprises: an enclosure and an electronics assembly contained substantially therein, the electronics assembly comprising a ground plane and at least one feed port; and a multiband antenna apparatus. The multiband antenna apparatus comprises: a first antenna structure comprising an element disposed substantially around an outside perimeter of the enclosure; and a second antenna structure comprising a plurality of monopole radiator branches. In one variant, the first antenna structure is connected to the ground plane in at least two ground points, thereby forming a virtual portion and an operational portion, the operational portion comprising a slot disposed in the element proximate a bottom side of the enclosure; an exterior perimeter of the virtual portion substantially envelops the ground plane; and an exterior perimeter of the operational portion is disposed external to the ground plane, and substantially envelops the second antenna structure.

In another embodiment, the mobile device comprises: a device enclosure; and an antenna having a substantially external radiator element, the radiator element having at least one slot disposed relative to the enclosure so as to minimize the potential for radiator element shorting across the slot due to device handling by a user during use of the device.

In one variant of the alternate embodiment, the radiator element comprises a substantially closed loop, and the at least one slot comprises a single slot disposed substantially on a bottom edge of the enclosure of the device, the bottom edge being not normally grasped by the user during the use of the device.

In another variant, the radiator element comprises a substantially closed loop disposed on top, bottom and side edges of the enclosure of the mobile device; and the at least one slot comprises a single slot disposed at either one of the top or the bottom edges.

In a second aspect of the invention, a multiband antenna apparatus is disclosed. In one embodiment, the apparatus is adapted for use in a portable radio communications device, and comprises: a first antenna structure comprising an element configured to be disposed substantially around an outside perimeter of a device enclosure. In one variant, the first antenna structure is connected to a ground plane of the device in at least two locations, thereby forming a virtual portion and an operational portion; and the operational portion comprises a slot formed in the element so as to be disposed proximate a bottom side of the enclosure.

In another variant, an exterior perimeter of the virtual portion substantially envelops the ground plane; and an exterior perimeter of the second antenna structure is disposed external to the ground plane.

In yet another variant, the slot is configured to effect antenna resonance in at least one upper frequency band.

In a third aspect of the invention, a method of operating a multiband antenna apparatus is disclosed. In one embodiment, the antenna apparatus if for use in a portable radio device and has a feed, a loop radiator element disposed substantially around a perimeter region of an enclosure of the device. The loop radiator element has a slot disposed substantially at a bottom edge of the enclosure, and a ground plane of the radio device is disposed a distance away from a bottom edge of the loop radiator element. The method comprises: energizing the feed with a feed signal comprising a lower frequency component and a higher frequency component; and causing radio frequency oscillations in the loop radiator element at least at the higher frequency. The slot is configured to effect tuning of the antenna apparatus in the range of the higher frequency.

In a fourth aspect of the invention, a method of mitigating the effects of user interference on a radiating and receiving mobile device is disclosed. In one embodiment, the mobile device is characterized by a preferred user grasping location, and the method comprises: energizing a loop antenna element with a signal comprising at least a first frequency component; the loop radiator element being disposed substantially around a perimeter region of an enclosure of the device, and causing an electromagnetic field across a slot formed within the loop antenna element. The slot is distally located relative to the preferred grasping location so as to mitigate electromagnetic interference due to the grasping by the user.

In a fifth aspect of the invention, a method of tuning a multiband antenna apparatus is disclosed.

Further features of the present invention, its nature and various advantages will be more apparent from the accompanying drawings and the following detailed description.

### BRIEF DESCRIPTION OF THE DRAWINGS

The features, objectives, and advantages of the invention will become more apparent from the detailed description set forth below when taken in conjunction with the drawings, wherein:

FIG. 1 is a side elevation view of a mobile device detailing a ring antenna apparatus configured according to one embodiment of the invention and installed therein.

FIG. 1A is a top plan view of a mobile device showing antenna apparatus of the embodiment of FIG. 1.

FIG. 1B is a block diagram detailing a multiband ring antenna tuning configuration according to one embodiment of the invention.

FIG. 1C is a block diagram detailing capacitive coupling of the multiband ring antenna of FIG. 1.

FIG. 2 is a schematic diagram detailing a multiband matching circuit according to one embodiment of the invention.

FIG. 3 is a plot of (i) measured free space input return loss, (ii) CTIA v3.1 beside head, right cheek return loss, and (iii) CTIA v3.1 beside head with hand, right cheek return loss measurements, obtained with an exemplary five-band antenna apparatus configured in accordance with the embodiment of FIG. 1A.

FIG. 4 is a plot of (i) measured total free space efficiency, (ii) CTIA v3.1 beside head, right cheek efficiency, and (iii) CTIA v3.1 beside head with hand, right cheek efficiency measurements, obtained with an exemplary multi-band antenna apparatus configured in accordance with the embodiment of FIG. 1A.

FIG. 5 is a plot of measured free space input return loss of an exemplary five-band antenna apparatus configured in accordance with the embodiment of FIG. 1A, and comprising the tuning circuit of FIG. 2.

All Figures disclosed herein are © Copyright 2011 Pulse Finland Oy. All rights reserved.

### DETAILED DESCRIPTION OF THE PREFERRED EMBODIMENT

Reference is now made to the drawings wherein like numerals refer to like parts throughout.

As used herein, the terms “antenna,” “antenna system,” “antenna assembly”, and “multi-band antenna” refer without limitation to any apparatus or system that incorporates a single element, multiple elements, or one or more arrays of elements that receive/transmit and/or propagate one or more frequency bands of electromagnetic radiation. The radiation may be of numerous types, e.g., microwave, millimeter wave, radio frequency, digital modulated, analog, analog/digital encoded, digitally encoded millimeter wave energy, or the like.

As used herein, the terms “board” and “substrate” refer generally and without limitation to any substantially planar or curved surface or component upon which other components can be disposed. For example, a substrate may comprise a single or multi-layered printed circuit board (e.g., FR4), a semi-conductive die or wafer, or even a surface of a housing or other device component, and may be substantially rigid or alternatively at least somewhat flexible.

The terms “frequency range”, “frequency band”, and “frequency domain” refer without limitation to any frequency range for communicating signals. Such signals may be communicated pursuant to one or more standards or wireless air interfaces.

As used herein, the terms “portable device”, “mobile computing device”, “client device”, “portable computing device”, and “end user device” include, but are not limited to, personal computers (PCs) and minicomputers, whether desktop, laptop, or otherwise, set-top boxes, personal digital assistants (PDAs), handheld computers, personal communicators, tablet computers, portable navigation aids, J2ME equipped devices, cellular telephones, smartphones, personal integrated communication or entertainment devices, or literally any other device capable of interchanging data with a network or another device.

Furthermore, as used herein, the terms “radiator,” “radiating plane,” and “radiating element” refer without limitation to an element that can function as part of a system that receives and/or transmits radio-frequency electromagnetic radiation; e.g., an antenna or portion thereof.

The terms “RF feed,” “feed,” “feed conductor,” and “feed network” refer without limitation to any energy conductor and coupling element(s) that can transfer energy, transform impedance, enhance performance characteristics, and conform impedance properties between an incoming/outgoing RF energy signals to that of one or more connective elements, such as for example a radiator.

As used herein, the terms “loop” and “ring” refer generally and without limitation to a closed (or virtually closed) path, irrespective of any shape or dimensions or symmetry.

As used herein, the terms “top”, “bottom”, “side”, “up”, “down”, “left”, “right”, and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

As used herein, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), analog cellular, CDPD, satellite systems such as GPS, millimeter wave or microwave systems, optical, acoustic, and infrared (i.e., IrDA).

### Overview

The present invention provides, in one salient aspect, a multiband antenna apparatus for use in a mobile radio device. The antenna apparatus advantageously provides reduced complexity and cost, and improved antenna performance, as compared to prior art solutions. In one embodiment, the mobile radio device comprises a metallic structure (e.g., a loop or ring) that at least partly encircles the outside perimeter of the device enclosure, and acts as the antenna radiating element. The “loop” radiator in one implementation comprises a single narrow slot disposed so as to minimize potential radiator shorting over the slot due to device handling during use, and to improve device visual appeal.

The exemplary embodiment of the multiband antenna apparatus further comprises a tuning circuit, including multiple branches each configured to effect antenna tuning in a predetermined frequency band. The metallic loop is grounded to the device ground plane at multiple locations, thus controlling the electrical length of the antenna. The dimensions of the slot are selected to optimize antenna performance in an upper frequency band of operation. The slot location effects low band lower band resonance frequency, which is configured to reside well below the lowest operating frequency of the antenna for proper operation of the radio device. In one approach, antenna lower band operation is tuned using an inductor connected in series between the feed and the lower band resonance circuit.

Advantageously, antenna coupling to the device electronics with the exemplary antenna disclosed herein is much simplified, as only a single feed connection is required (albeit not limited to a single feed). In one particular implementation, an upper frequency band tuning strip is galvanically connected to the loop element, thereby enabling tuning of the highest upper band resonances without changing or adversely affecting the visual appearance of the device

In another implementation, the tuning element is capacitively coupled via an electromagnetic field induced over a non-conductive gap between the tuning strip and the loop radiator.

Methods of tuning and operating the antenna apparatus are also disclosed.

### Detailed Description of Exemplary Embodiments

Detailed descriptions of the various embodiments and variants of the apparatus and methods of the invention are now provided. While primarily discussed in the context of mobile devices, the various apparatus and methodologies discussed herein are not so limited. In fact, many of the apparatus and methodologies described herein are useful in any number of complex antennas, whether associated with mobile or fixed devices, cellular or otherwise.

### Exemplary Antenna Apparatus

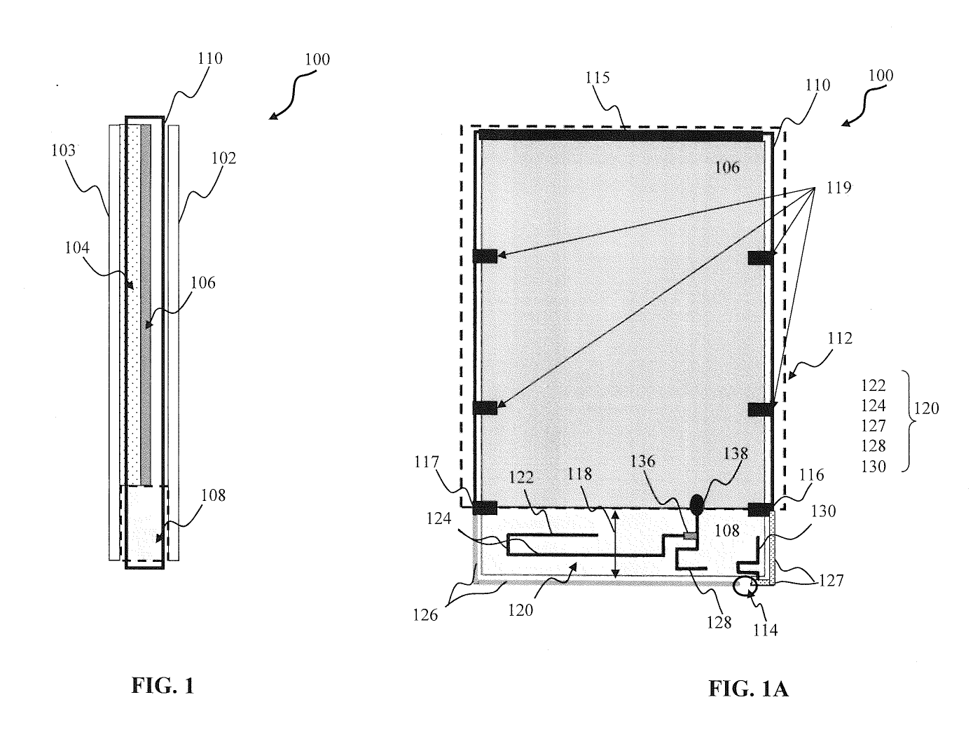

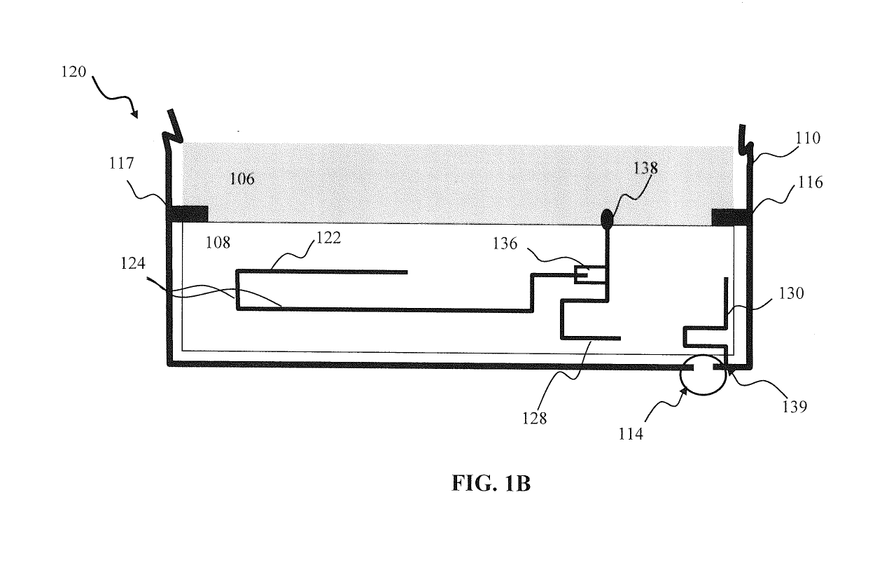

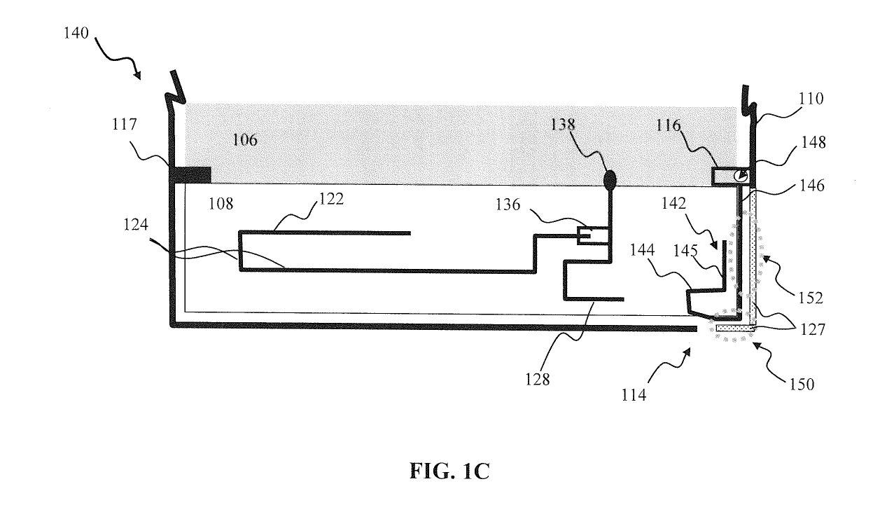

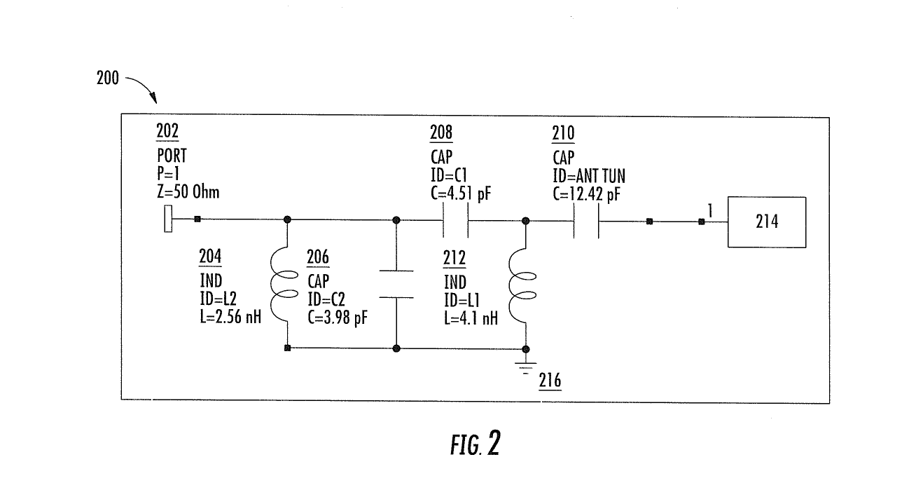

Referring now to FIGS. 1 through 2, exemplary embodiments of the radio antenna apparatus of the invention are described in detail. One exemplary embodiment of the antenna apparatus for use in a mobile radio device is presented in FIG. 1, showing a side elevation view of the host mobile device 100. The device 100 comprises a display module 104 and a corresponding ground plane 106 disposed in-between two dielectric covers 102, 103. In one variant, one of the dielectric covers 103 comprises an opening corresponding to the display perimeter, so as to enable e.g., touch-screen or other interactive functionality. Notwithstanding, the display 104 may comprise e.g., a display-only device configured only to display information, a touch screen display (e.g., capacitive or other technology) that allows users to provide input into the device via the display 104, or yet other technology. The display 104 may comprise, for example, a liquid crystal display (LCD), light-emitting diode (LED) display, LED-LCD display, organic light emitting diode (OLED) display, or TFT-based device. It is appreciated by those skilled in the art that methodologies of the present invention are equally applicable to any future display technology, provided the display module is generally mechanically compatible with device and antenna configurations such as those described in FIG. 1 through FIG. 2.

A metal loop or ring 110 is disposed substantially at the outside perimeter of the device housing, as shown in FIG. 1. The ring structure of this embodiment provides mechanical rigidity, structural integrity for the device, as well as enhances aesthetic appeal. In one variant (not shown), the ring 110 is replaced with a metal segment (e.g., a portion of the loop) encompassing a portion of the device perimeter.

The ring 110 of FIG. 1 can be fabricated using any of a variety of suitable methods including for example metal casting, stamping, metal strip, or a conductive coating disposed on a non-conductive carrier (such as plastic).

FIG. 1A is a top plan view detailing the exemplary antenna structure of the embodiment of FIG. 1. The ring 110 is connected to the ground plane 106 at multiple locations 116, 117, 119. Furthermore, the top portion of the ring is attached to the ground plane along the top perimeter structure 115.

The ground points 116, 117 are used for antenna tuning, and their locations effectively define the length of the ring or loop antenna operational portion (i.e., the portion of the antenna that emits/receives RF radiation). The ground points 115, 119 are preferably separated by a distance that is less than a quarter wavelength of the antenna (at the highest operating frequency). In one variant, the ground structure 115 is configured to cover the majority of the upper edge of the ring, as shown in FIG. 1A. In another variant (not shown), the ground point 115 grounds a portion of the upper ring edge.

The ring upper part (i.e., bounded by the ground points 116, 117, 119, 115 and marked by the broken line rectangle 112 in FIG. 1A) forms a grounded (or virtual) portion. The virtual antenna portion is configured to be at the same potential as the ground plane. Such configuration minimizes unwanted antenna RF radiation being emitted from the antenna grounded portion and further reduces antenna susceptibility to shorting and loading effects due to handling of the mobile device by users during operation. In one variant, the upper ring portion may be removed as required by the enclosure design to simplify assembly and reduce cost of the radio device. In another variant, the ring is used to provide device structural support and visual appeal.

As a brief aside, the antenna of the embodiment shown in FIGS. 1-1A is configured to operate in both low and high frequency (relative to one another) operational ranges. In one variant, the low operating frequency range is between about 800 MHz and about 960 MHz, and the high operational frequency range is between about 1700 MHz and 2200 MHz. As will be appreciated by those skilled in the art, the above frequency bounds are exemplary, and can be changed from one implementation to another based on specific design requirements and parameters, such as for example antenna size, target country of device operation, etc. Typically, each of the operational frequency ranges may support one or more distinct frequency bands configured in accordance with the specifications governing the relevant wireless application system (such as, for example, LTE/LTE-A or GSM). One antenna embodiment, shown and described with respect to FIG. 1A herein, may support one or two lower frequency bands (LFB1, LFB2) and at least three upper frequency bands (UFB1, UFB2, UFB3). In another embodiment, the high frequency operational range (e.g., between about 2500 MHz and about 2700 MHz) is used to enable antenna operation in a fourth upper frequency band (UFB4).

Returning now to FIG. 1A, the bottom part of the loop or ring structure (disposed below the virtual portion 112) forms an operational structure of the antenna radiator, and is referred to herein as the ring or loop operational portion. One ground point 116 determines the electrical length of the operational portion in the high frequency range, while another ground point 117 determines the antenna electrical length in the low frequency range. The ring 110 of this embodiment comprises a narrow slot 114 disposed along the bottom edge of the host device, and is configured to effect antenna tuning in the high frequency range. In one variant, the slot is about 0.8 mm in width, although other values may be used depending on the desired performance and physical attributes. In order to maintain device aesthetic appeal and to increase structural integrity of the enclosure, the slot may be filled with a dielectric material (such as e.g., plastic).

Moreover, the present invention contemplates the use of (i) a slot with a varying or non-constant width (that is: different slot width at different locations across the ring thickness); and (ii) use of two or more slots.

In the embodiment of FIG. 1A, the ground plane 106 is spaced from the bottom edge of the ring 110 by a prescribed distance 118; e.g., about 13 mm. The ground-free bottom portion 108 of the device houses the antenna tuning structure 120. The tuning structure 120 is configured to effect simultaneous operation of the antenna in lower and upper operating frequency bands of the portable radio device 100. The structure 120 is coupled to the feed electronics of the device at a feed point 138, and comprises several tuning branches 122, 124, 128, 130.

Antenna frequency tuning in the illustrated embodiment is achieved as follows: the tuning branch 124 effects antenna tuning in a first lower frequency band (LFB1), which corresponds to antenna low frequency resonance f₁. In one variant, the LFB1 comprises frequency band from 824 to 894 MHz, and f₁ is centered at about 850 MHz (also referred to as the 850 MHz band). In another variant, the LFB1 comprises frequency band from 880 to 960 MHz, and f₁ is centered at about 900 MHz (also referred to as the 900 MHz band).

In one variant of the embodiment of FIG. 1A, a series tuning circuit 136 is disposed between the feed 136 and the horizontal portion of the branch 124. The tuning circuit 136 is configured to adjust the electric length of the lower frequency antenna resonator, and to increase the antenna operational bandwidth in the lower band. This increased lower frequency bandwidth enables antenna operation in two lower frequency bands LFB1, LFB2.

In one implementation, the tuning circuit 136 comprises a coil configured to provide a series inductance of about 10 nano-Henry (nH) to the radiator branch 124, with LFB1 being the 850 MHz band, and LFB2 being the 900 MHz band. As will be appreciated by those skilled in the art, other tuning element implementations are equally applicable to the invention including, but not limited to a discrete inductor, a capacitive element, or a combination thereof.

Antenna operation of the embodiment shown in FIG. 1A in the LFB1 (and LFB2) band is tuned by the overall length of the resonator 124, and the reactance value of the tuning element 136. The long section 126 (formed between the ground point 117 and the slot 114) of the ring structure bottom portion forms a resonance at frequency f₀. In order to achieve desired antenna operation at lower frequencies (e.g., LFB1, LFB2) and to prevent coupled low frequency resonances, the f₀ resonance is tuned to be below the antenna low operating frequency range (for example, 820 to 960 MHz). In one variant, the bottom portion resonance frequency f₀ is selected at about 600 MHz.]

The antenna high frequency operational range is formed by at least two high frequency resonances, hereinafter referred to as the f₂ resonance and the f₃ resonance. The first high frequency resonance (f₂) is formed by the shorter portion 127 of the ring 110 formed between the slot 114 and the ground point 116. Antenna tuning of this resonance is achieved in the illustrated embodiment by varying the length of the strip in the tuning branch 130. The tuning branch 130 is coupled to the ring 110 either galvanically or capacitively, as described in detail below with respect to FIGS. 1B-1C.

The directly fed antenna high frequency tuning structure 128 is configured to form a resonance at the second high frequency resonance (f₃). The value of the f₃ resonance is tuned in the illustrated embodiment by the length of the tuning branch 128 (and its proximity to the bottom portion of the ring). Each of the f₂ and f₃ resonances may be configured to provide antenna functionality in one or more upper frequency bands.

In one variant, the combination of f₂ and f₃ resonance bands spans a frequency range from about 1710 MHz to 2170 MHz, thus enabling device operation in the following high-frequency bands of an LTE-compliant system: 1710-1880 MHz, 1850-1990 MHz, and 1930-2170 MHz, corresponding to UFB1-UFB3, respectively.

In another embodiment, the directly fed low frequency range radiating structure 122 is used, in combination with the tuning branch 124, to form a harmonic resonance, referred to as the f₄ resonance, of a frequency component of the low frequency range, thereby effecting antenna operation in a fourth upper frequency band (UFB4). The value of the UFB4 is tuned by the length of the horizontal branch 122 of the C-shaped structure (having two turns) formed by the tuning branches 122, 124 of FIG. 1A.

Referring now to FIGS. 1B-1C, two exemplary embodiments of the antenna tuning structure are shown and described. The antenna tuning structure 120 of FIG. 1B corresponds to the antenna embodiment of FIG. 1A and comprises the f₂ tuning branch 130 that is directly connected to the ring structure 110 at a point 139.

In another embodiment (shown in FIG. 1C), the tuning branch 142 of the tuning structure 140 comprises two vertical strips 145, 146 and a loop structure 144 disposed there between. The vertical strip 146 is grounded at a ground point 148. The tuning branch 142 is electrically isolated from the ring 110. In one variant, the isolation is effected by a thin layer of dielectric material disposed along the inner surface of the ring 110. The tuning branch 142 is capacitively coupled to the ring 110 via an electric field induced over non-conductive gaps 150, 152. In one implementation, the gap is selected to be about 0.3 mm in width, although other values may be used with equal success.

In the capacitive coupling setup, the dielectric gap between the tuning strip and the operational portion of the metal ring needs to be sufficiently small in order to form the gap resonance above the highest operating frequency of the antenna. Capacitive coupling of the tuning branch to the ring structure does not require any physical attachment (e.g., soldering, welding) of the tuning structure to the ring, therefore advantageously facilitating antenna manufacturing and allowing for a wider range of material selection.

The gap between the ring portion 127 and the tuning branch 142 causes a gap resonance at a frequency that is defined by the capacitance between the surfaces of the ring portion 127 and the tuning branch 142 due to a strong electric field between these surfaces. Reducing the gap creates a tighter coupling between these elements, and shifts the gap resonance frequency higher and beyond the antenna operating bands. The gap resonance frequency is further affected by the size the overlapping surface area (also referred to as the coupling area) between the strips 144, 146 of the tuning branch 142 and the ring portion 127. Larger coupling area allows for a larger gap.

In another embodiment (not shown), the multiband antenna is configured without the tuning element 136, thereby forming a 4-band resonator with a single lower band frequency band LFB1 and three upper frequency bands (UFB1, UFB2, UFB3).

In another aspect of the invention, the antenna structure (such as that shown in FIG. 1A) is fitted with a tuning network in order to optimize antenna performance; e.g., to increase antenna efficiency and reduce losses. FIG. 2 shows one embodiment of such tuning network configured to operate in four or more frequency bands, here within the frequency range from about 800 kHz to 2700 MHz. The network 200 comprises an input port 202, characterized by the nominal impedance of 50 Ohm, which is connected to the feed port of the portable device electronics. The circuit ground point 216 is connected to the device ground plane, and the circuit output port 214 is connected to antenna radiating structure, such as, for example, the feed point 138 in FIG. 1A. The inductive element 204 and the capacitive element 206 form a first resonance circuit (L2C2) configured to effect antenna tuning in the LFB2 and the UFB4 frequency bands. Exemplary values of the capacitive elements 206, 208, 210 and the inductive 204, 212 elements, are as illustrated in FIG. 2. A first inductive element 212 and first capacitive element 208 control impedance transformation between the antenna radiator and the L2C2 circuit. The second capacitive element 210 is used for tuning purposes, and may be omitted in some implementations if desired. It will be recognized that the exact component values and/or tuning network configuration are/is selected based on specific application and parametric requirements, and may change from one application to another, such values being readily determined by those skilled in the electronic arts given this disclosure.

### Performance

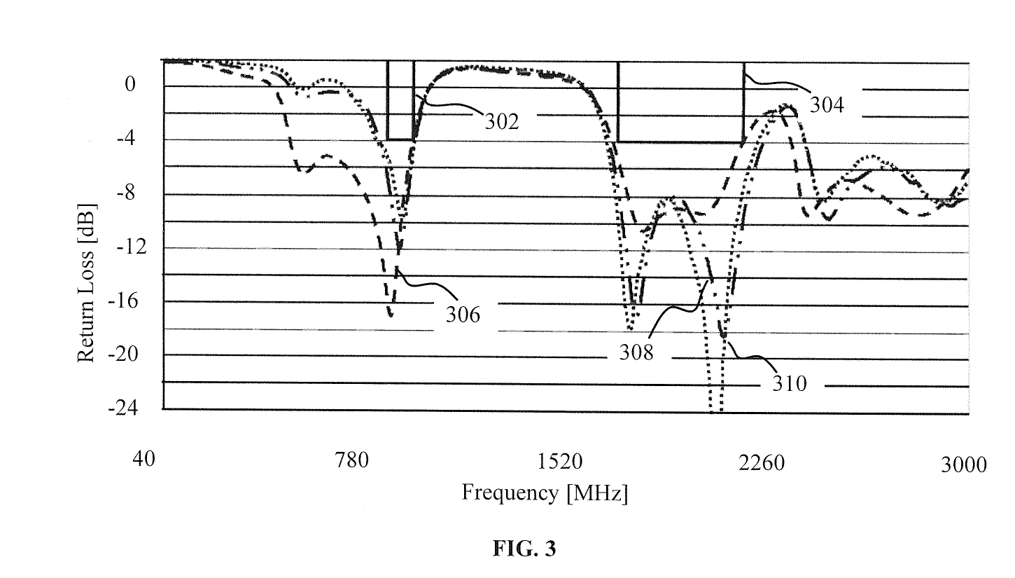

FIGS. 3 through 5 present performance results obtained during simulation and testing by the Assignee hereof of an exemplary antenna apparatus constructed according to one embodiment of the invention.

FIG. 3 shows a plot of free-space return loss S11 (in dB) as a function of frequency, measured with the four-band multiband antenna constructed similarly to the embodiment depicted in FIG. 1A. The antenna four frequency bands include one 900 MHz low frequency band, and three upper frequency bands (1710-1880 MHz, 1850-1990 MHz, and 1930-2170 MHz). The solid line designated with the designator 302 in FIG. 3 marks the boundaries of the lower frequency band, while the line designated with the designator 304 marks the boundaries of the high frequency range between 1710 and 2170 MHz. The curves marked with designators 306-310 correspond to measurements obtained in the following device configurations: (i) the first curve 306 is taken in free space; (ii) the second curve 308 is taken according to CTIA v3.1 beside head, right cheek (BHR) measurement configuration; and (iii) the third curve 310 is taken according to CTIA v3.1 beside head with hand, right cheek (BHHR) measurement configuration. Data presented in FIG. 3 demonstrate that the exemplary antenna comprising a single small slot positioned along the bottom of the device is advantageously not detuned off-band by the presence of the user's hand, and a 6 dB return loss is maintained throughout the BHHR measurements.

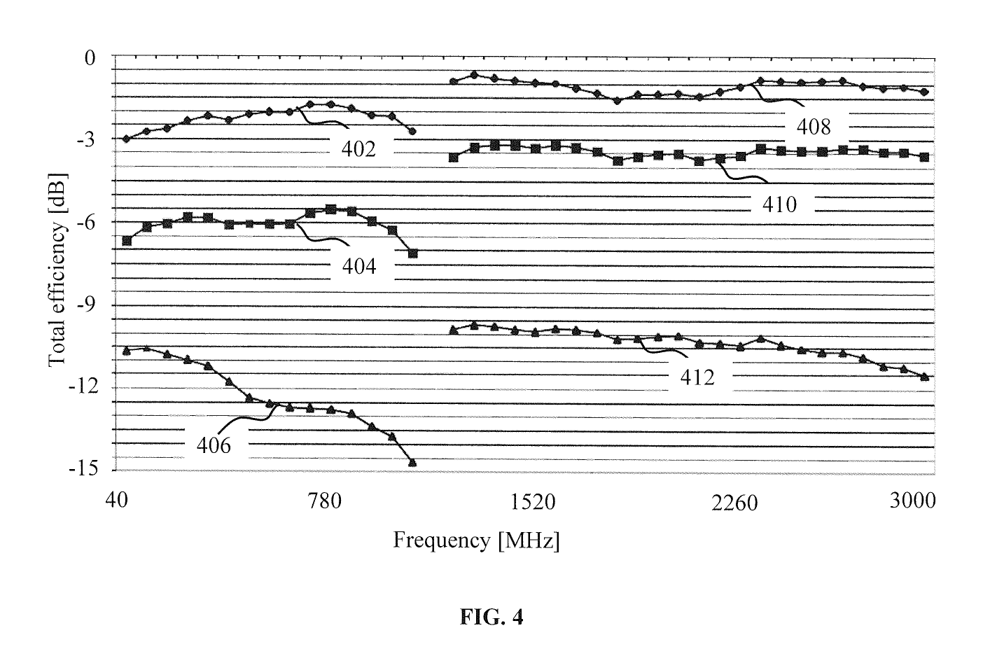

FIG. 4 presents data regarding measured free-space efficiency for the same antenna as described above with respect to FIG. 3. Efficiency of an antenna (in dB) is defined as decimal logarithm of a ratio of radiated to input power:

$$AntennaEfficiency = 10 {log}_{10} ( \frac{Radiated Power}{Input Power} ) \qquad Eqn . ( 1 )$$

An efficiency of zero (0) dB corresponds to an ideal theoretical radiator, wherein all of the input power is radiated in the form of electromagnetic energy.

The curves marked with designators 402-412 in FIG. 4 correspond to measurements obtained in the following device configurations: (i) curves 402, 408 are taken in free space; (ii) curves 404, 410 are taken according to CTIA v3.1 beside head, right cheek (BHR) measurement configuration; and (iii) curves 406-412 are taken according to CTIA v3.1 beside head with hand, right cheek (BHHR) measurement configuration. The data in FIG. 4 demonstrate that the antenna embodiment constructed according with the principles of the present invention is not susceptible to higher losses due to user hand and head proximity, thereby enabling robust operation of the radio device.

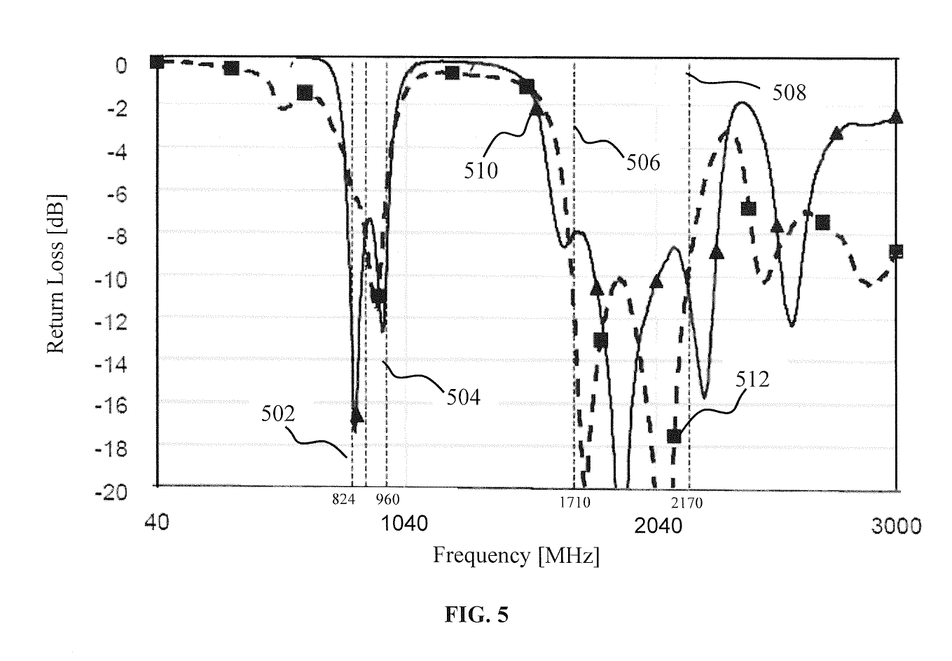

FIG. 5 shows a plot of free-space return loss S11 (in dB) as a function of frequency, obtained for the five-band multiband antenna constructed in accordance with the embodiment depicted in FIG. 1A, and utilizing the tuning circuit of the embodiment of FIG. 2 herein. The antenna frequency bands include 850 and 900 MHz (the two low frequency bands), and 1710-1880 MHz, 1850-1990 MHz, and 1930-2170 MHz (the three upper frequency bands). Designators 502, 504 mark the lower (824 MHz) and the upper (960 MHz) extents of the lower frequency range, while designators 506, 508 mark the lower (1710 MHz) and the upper (2170 MHz) extents of the upper frequency range, respectively. The curve with designator 512 corresponds to the measured response of the 4-band antenna described with respect to FIG. 3, supra. The curve marked with designator 510 depicts antenna response simulated using the matching circuit 200 of the embodiment of FIG. 2. A measured s-parameter of the circuit 200 was used in simulating the response 510.

Comparison between the two antenna responses 510, 512 demonstrates an increased antenna bandwidth in the lower frequency range for the response 510, which allows antenna operation in the 850 MHz and 900 MHz lower frequency bands.

The data presented in FIGS. 3-5 demonstrate that a loop or ring antenna configured with a narrow slot is capable of operation within a wide frequency range; i.e., covering the lower frequency band from 824 to 960 MHz, as well as the higher frequency band from 1710 MHz to 2170 MHz. This capability advantageously allows operation of a portable computing device with a single antenna over several mobile frequency bands such as GSM850, GSM900, GSM1900, GSM1800, PCS-1900, as well as LTE/LTE-A and/or WiMAX (IEEE Std. 802.16) frequency bands. Furthermore, the use of a separate tuning branch enables formation of a higher order antenna resonance, therefore enabling antenna operation in an additional high frequency band (e.g., 2500-2600 MHz band). Such capability further expands antenna uses to Wi-Fi (802.11) and additional LTE/LTE-A bands. As persons skilled in the art will appreciate, the frequency band composition given above may be modified as required by the particular application(s) desired, and additional bands may be supported/used as well.

Advantageously, the slotted loop or ring antenna configuration (as in the illustrated embodiments described herein) further allows for improved device operation by reducing potential for antenna shorting (and associated adverse effects) due to user handling, in addition to the aforementioned breadth and multiplicity of operating bands. Furthermore, the use a bottom-placed gap (for example, a small single gap as shown in the exemplary embodiments herein) improves device aesthetic appeal in that the bottom of the device is rarely if ever seen during use, and reduces the need for non-conductive or decorative covering elements (often required in prior art solutions), thereby reducing the device cost as well.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A mobile communications device, comprising:
an enclosure and an electronics assembly contained substantially therein, said electronics assembly comprising a ground plane and at least one feed port; and
a multiband antenna apparatus, comprising:
a first antenna structure comprising an element disposed substantially around an outside perimeter of the enclosure; and
a second antenna structure comprising a plurality of monopole radiator branches; wherein:
the first antenna structure is connected to the ground plane in at least two ground points, thereby forming a virtual portion and an operational portion, the operational portion comprising a slot disposed in the element proximate a bottom side of the enclosure;
an exterior perimeter of the virtual portion substantially envelops the ground plane; and
an exterior perimeter of the operational portion is disposed external to the ground plane, and substantially envelops the second antenna structure.

2. A multiband antenna apparatus for use in a portable radio communications device, the antenna apparatus comprising:
a first antenna structure comprising an element configured to be disposed substantially around an outside perimeter of a device enclosure;
wherein:
the first antenna structure is connected to a ground plane of the device in at least two locations, thereby forming a virtual portion and an operational portion; and
the operational portion comprises a slot formed in the element so as to be disposed proximate a bottom side of the enclosure.

3. The antenna apparatus of claim 2, wherein the slot is configured to effect antenna resonance in at least one upper frequency band.

4. The antenna apparatus of claim 2, further comprising a second antenna structure comprising a plurality of monopole radiator branches, wherein the plurality of monopole radiator branches comprises:
a first radiator branch electrically coupled to a feed port of the device, and configured to operate in a first upper frequency band;
a second radiator branch coupled to the feed port of the device, and configured to operate in a second upper frequency band; and
a third radiator branch electrically coupled to the feed port of the device, and configured to operate in a first lower frequency band.

5. The antenna apparatus of claim 4, wherein:
an exterior perimeter of the virtual portion substantially envelops the ground plane; and
an exterior perimeter of the second antenna structure is disposed external to the ground plane.

6. The antenna apparatus of claim 4, further comprising a reactive circuit coupled between the third radiator branch and the feed port.

7. The antenna apparatus of claim 6, wherein the reactive circuit comprises at least one of (i) an inductive element, and/or (ii) a capacitive element.

8. The antenna apparatus of claim 6, wherein a second reactive circuit is configured to adjust electrical length of the third radiator branch.

9. The antenna apparatus of claim 6, wherein the first lower frequency band comprises a GSM band, and the first and the second upper frequency bands are selected from a group consisting 1700 MHz, 2100 MHz, and 2500 MHz bands.

10. The antenna apparatus of claim 4, wherein the slot is disposed proximate a lower corner of the device enclosure.

11. The antenna apparatus of claim 2, wherein the at least two locations are configured to affect electrical length of the element.

12. The antenna apparatus of claim 11, wherein the at least two locations comprise (i) a first ground structure disposed on a first side of the element, and (ii) a second ground structure disposed on a second side of the element, the second side opposing the first side, such that the first ground structure and the second ground structure are configured distant to the slot.

13. The antenna apparatus of claim 2, wherein a portion of said element is disposed proximate the bottom side and is spaced from the ground plane along substantially a lateral extent of the bottom side.

14. A mobile device, comprising:
a device enclosure; and
an antenna having a substantially external radiator element, the radiator element having at least one slot disposed relative to said enclosure so as to minimize potential for radiator element shorting across the slot due to device handling by a user during use of the device.

15. The mobile device of claim 14, wherein said radiator element comprises a substantially closed loop, and said at least one slot comprises a single slot disposed substantially on a bottom edge of said enclosure of said device, said bottom edge being not normally grasped by said user during said use of the device.

16. The mobile device of claim 14, wherein:
said radiator element comprises a substantially closed loop disposed on a top edge, a bottom edge, and side edges of said enclosure of said mobile device; and
said at least one slot comprises a single slot disposed at either one of said top edge or said bottom edge.

17. The mobile device of claim 14, wherein:
said radiator element comprises a first structure being connected to a ground plane of the device in at least two locations so as to form a virtual portion and an operational portion; and
said slot is disposed in said operational portion on a bottom side of the device enclosure.

18. The mobile device of claim 17, wherein:
said radiator element further comprises a radiator structure comprising a plurality of monopole radiator branches.

19. The mobile device of claim 18, wherein an exterior perimeter of the operational portion is disposed external to the ground plane, and substantially envelops the radiator structure.

20. The mobile device of claim 18, wherein the plurality of monopole radiator branches comprises:
a first radiator branch electrically coupled to a feed port of the device, and configured to operate in a first frequency band;
a second radiator branch coupled to the feed port of the device, and configured to operate in a second frequency band; and
a third radiator branch electrically coupled to the feed port of the device, and configured to operate in a third frequency band.

21. The mobile device of claim 20, wherein each of the plurality of monopole radiator branches comprises a conductive strip having at least one turn.

22. The mobile device of claim 21, wherein said least one turn forms at least a portion of a C-shaped structure.

23. The mobile device of claim 20, wherein the third radiator branch is further configured to operate in a fourth frequency band having a resonance proximate a harmonic of a resonance of the third frequency band.

24. The mobile device of claim 20, wherein:
said radiator element comprises a substantially closed loop; and
said second radiator branch is electrically coupled to the loop proximate the slot.

25. The mobile device of claim 20, wherein:
said radiator element comprises a substantially closed loop element; and
said second radiator branch is electromagnetically coupled over a non-conductive gap to the loop element proximate the slot.

26. The mobile device of claim 14, wherein said radiator element comprises a substantially closed loop, said loop forming a single contiguous structure.

27. A method of operating a multiband antenna apparatus for use in a portable radio device, the apparatus having a feed, a loop radiator element disposed substantially around a perimeter region of an enclosure of the device, the loop radiator element having a slot disposed substantially at a bottom edge of said enclosure, and a ground plane of the radio device disposed a distance away from a bottom edge of said loop radiator element, the method comprising;
energizing the feed with a feed signal comprising a lower frequency component and a higher frequency component; and
causing radio frequency oscillations in said loop radiator element at least at said higher frequency;
wherein, the slot is configured to effect tuning of the antenna apparatus at the higher frequency.

28. A method of mitigating effects of user interference on a radiating and receiving mobile device, the mobile device characterized by a preferred user grasping location, the method comprising:
energizing a loop antenna element with a signal comprising at least a first frequency component; the loop antenna element being disposed substantially around a perimeter region of an enclosure of the device, and
causing an electromagnetic field across a slot formed within said loop antenna element;
wherein the slot is distally located relative to the preferred grasping location so as to mitigate electromagnetic interference due to said grasping by said user.
